(19) United States
(12) Patent Application Publication
(10) Pub. No.: US 2026/0200788 A1
(43) Pub. Date: Jul. 16, 2026

(54) GLASS ARTICLE AND ELECTRONIC DEVICE

(71) Applicant: AGC INC., Tokyo (JP)

(72) Inventors: Atsushi TSUNODA, Koriyama-shi (JP); Atsushi MATSUO, Koriyama-shi (JP); Koji MIYASAKA, Tokyo (JP); Misao MOMII, Tokyo (JP); Isamu HOJO, Tokyo (JP)

(73) Assignee: AGC INC., Tokyo (JP)

(21) Appl. No.: 19/563,797

(22) Filed: Mar. 11, 2026

Related U.S. Application Data
(63) Continuation of application No. PCT/JP2024/033933, filed on Sep. 24, 2024.

(30) Foreign Application Priority Data
Sep. 29, 2023 (JP) 2023-169969

(51) Int. Cl. C03C 3/083

(52) U.S. Cl. CPC C03C 3/083

(57) ABSTRACT

A glass article includes a glass plate having a hole in a surface and a glass block that fills the hole in the glass plate. The glass plate is formed of a first glass material, and the glass block is formed of a second glass material having a different composition from the first glass material. A glass transition point (Tg1) of the first glass material is higher than a glass transition point (Tg2) of the second glass material. An absolute value (ΔCTE=|CTE1−CTE2|) of a difference between an average coefficient of linear expansion (CTE1) of the first glass material and an average coefficient of linear expansion (CTE2) of the second glass material is less than 35.8×10⁻⁷/° C.

The present application is a continuation of PCT/JP2024/033933, filed on Sep. 29, 2023, the entire contents of which are incorporated herein by reference.

### TECHNICAL FIELD

The present disclosure relates to a glass article and an electronic device.

### BACKGROUND ART

Patent Documents 1 and 2 describe a molding method for integrating a first glass and a second glass that differ in at least one of a composition and a color tone. In Patent Document 1, after the first glass and the second glass are accommodated in a mold in a state in which the first glass is disposed to surround the second glass, the first glass and the second glass are integrated by heating them to a softening point or higher. In Patent Document 2, the first glass in a molten state and the second glass in a solidified state are brought into contact with each other and slowly cooled and integrated. In Patent Documents 1 and 2, the first glass is black colored glass, and the second glass is transparent glass.

### CITATION LIST

### Patent Document

Patent Document 1: Japanese Unexamined Patent Application, First Publication No. 2013-060336
Patent Document 2: Japanese Unexamined Patent Application, First Publication No. 2012-254898

### SUMMARY OF INVENTION

### Technical Problem

A glass article including a glass plate and a glass block that fills a hole in the glass plate is conceivable. The glass plate is formed of a first glass material, and the glass block is formed of a second glass material having a different composition from the first glass material. Conventionally, when the glass plate and the glass block are integrated, the hole in the glass plate may become distorted. In addition, cracks may occur.

One aspect of the present disclosure provides a technique for reducing distortion of a hole in a glass plate and minimizing the occurrence of cracks.

### Solution to Problem

A glass article according to one aspect of the present disclosure includes a glass plate having a hole in a surface and a glass block that fills the hole in the glass plate. The glass plate is formed of a first glass material, and the glass block is formed of a second glass material having a different composition from the first glass material. A glass transition point (Tg1) of the first glass material is higher than a glass transition point (Tg2) of the second glass material. An absolute value (ΔCTE=|CTE1−CTE2|) of a difference between an average coefficient of linear expansion (CTE1) of the first glass material and an average coefficient of linear expansion (CTE2) of the second glass material is less than 35.8×10⁻⁷/° C.

### Advantageous Effects of Invention

According to one aspect of the present disclosure, Tg1 is higher than Tg2, and the glass plate is less likely to deform due to heat than the glass block. Therefore, when the glass plate and the glass block are integrated while heating, the glass block can be deformed to fill the hole with the glass block while curbing deformation of the hole in the glass plate, and distortion of the hole in the glass plate can be reduced. In addition, since ΔCTE is less than 35.8×10⁻⁷/° C., stress due to the difference in thermal expansion is small. Therefore, the occurrence of cracks can be minimized.

### BRIEF DESCRIPTION OF DRAWINGS

FIG. 1A is a plan view of a glass article according to one embodiment.

FIG. 1B is a cross-sectional view of the glass article according to one embodiment.

FIG. 2 is a cross-sectional view showing an example of transmission of visible light in the glass article shown in FIG. 1B.

FIG. 3 is a flowchart illustrating an example of a method of producing a glass article.

FIG. 4A is a cross-sectional view showing an example of S101.

FIG. 4B is a cross-sectional view showing an example of S102.

FIG. 4C is a cross-sectional view showing an example of S103.

FIG. 5A is a plan view of a glass article according to a first modified example.

FIG. 5B is a cross-sectional view of the glass article according to the first modified example.

FIG. 6A is a plan view of a glass article according to a second modified example.

FIG. 6B is a plan view of a glass article according to a third modified example.

FIG. 6C is a plan view of a glass article according to a fourth modified example.

### DESCRIPTION OF EMBODIMENTS

Forms for implementing the present disclosure will be described below with reference to the drawings. In the drawings, identical or corresponding components are denoted with the same reference numerals and descriptions thereof may be omitted. In this specification, when a numerical value range is indicated using “to,” it means that numerical values stated before and after “to” are included as a lower limit value and an upper limit value. The numerical value range includes a range that is rounded off.

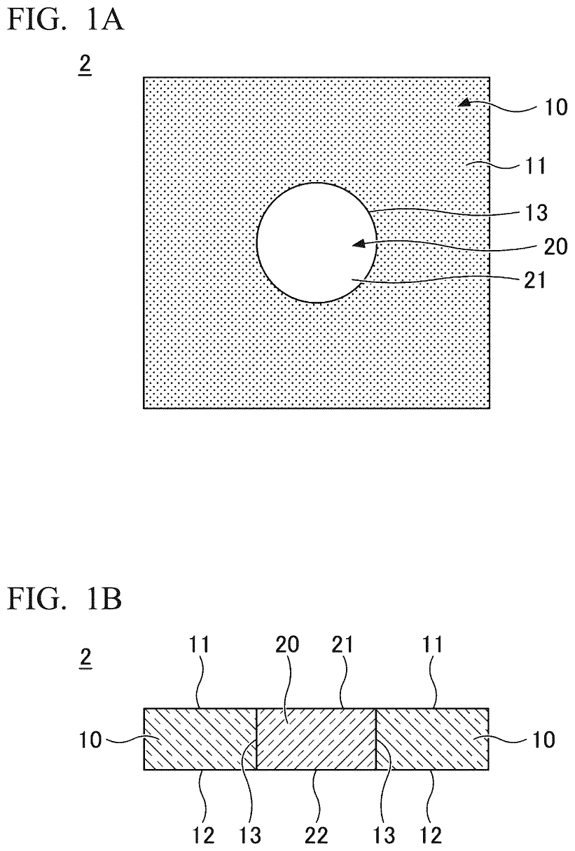

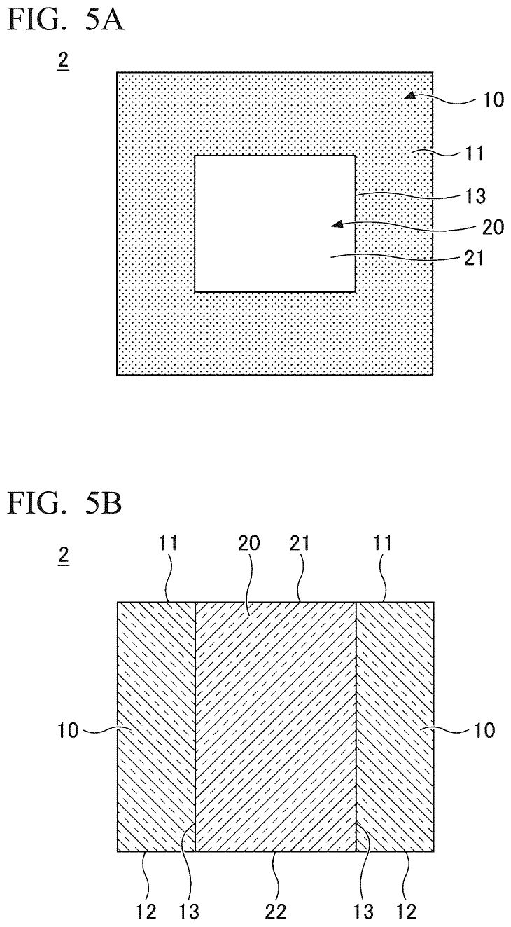

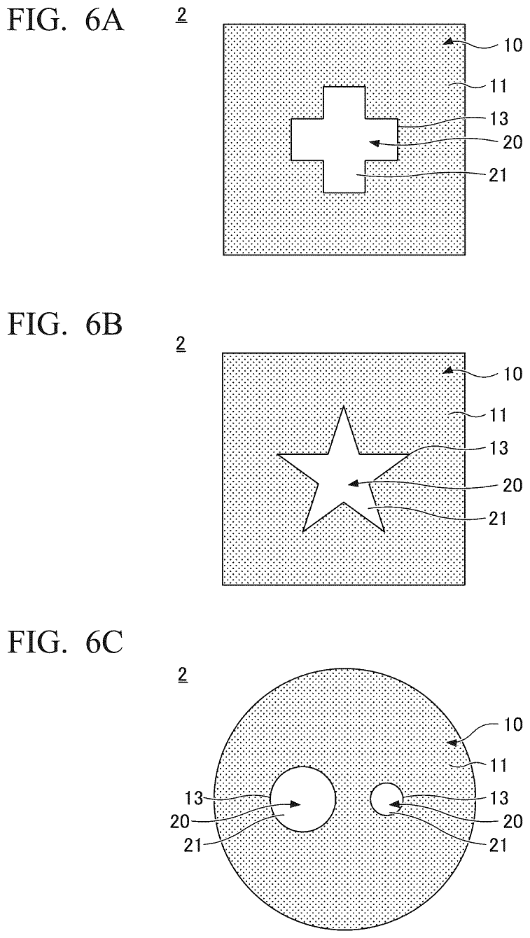

A glass article 2 according to one embodiment will be described with reference to FIG. 1A and FIG. 1B. In FIG. 1A, a dot pattern region indicates a region formed of a first glass material, and a white region indicates a region formed of a second glass material. The first glass material is, for example, black glass, and the second glass material is, for example, transparent glass. Also in FIG. 5A, FIG. 6A, FIG. 6B and FIG. 6C to be described below, a dot pattern region indicates a region formed of a first glass material, and a white region indicates a region formed of a second glass material.

The glass article 2 includes a glass plate 10 and a glass block 20. The glass plate 10 has a hole 13 in a surface 11. The glass block 20 fills the hole 13 in the glass plate 10. The glass plate 10 is formed of a first glass material, and the glass block 20 is formed of a second glass material having a different composition from the first glass material. The glass composition is measured by X-ray fluorescence analysis (XRF). When the glass plate 10 and the glass block 20 have a chemically strengthened layer to be described below, the chemically strengthened layer is removed and the glass composition is then measured.

The first glass material and the second glass material are not particularly limited, and examples thereof include soda lime glass, alkali-free glass, chemically strengthened glass, borosilicate glass, and lanthanum borate glass. The first glass material and the second glass material may be partially crystallized. When the first glass material and the second glass material are chemically strengthened glass, they preferably contain 1 mol % to 30 mol % of Al₂O₃ and 1 mol % to 20 mol % of Na₂O.

The chemically strengthened glass has a chemically strengthened layer on its surface. The chemically strengthened layer is a layer in which compressive stress is introduced by exchanging alkali metal ions (for example, Na ions) contained in the glass with alkali metal ions (for example, K ions) having a larger ionic radius at a temperature equal to or lower than the glass transition point. The ion exchange is performed after the glass plate 10 and the glass block 20 are thermally integrated.

The chemically strengthened glass contains, in terms of mol % based on oxides, for example, 45% to 75% of SiO₂, 1% to 30% of Al₂O₃, 1% to 20% of Li₂O, 0% to 5% of Y₂O₃, 0% to 5% of ZrO₂, and 0% to 1% of TiO₂, and a total amount of 1% to 20% of any one of MgO, CaO, SrO, BaO and ZnO, a total amount of 0% to 10% of Na₂O and K₂O, and a total amount of 0% to 10% of B₂O₃ and P₂O₅.

In consideration of a recycling property of the chemically strengthened glass, an absolute value of a difference between (K content/Na content) in the entire chemically strengthened glass and (K content/Na content) in the center of the chemically strengthened glass is preferably 1% or less of (K content/Na content) in the center of the chemically strengthened glass. Here, the entire chemically strengthened glass has a chemically strengthened layer, and the center of the chemically strengthened glass does not have a chemically strengthened layer. The K content and the Na content are expressed in mol %. When the absolute value of the difference is 1% or less, the change in composition due to chemical strengthening is small, and the recycling property is good.

The first glass material may be black glass, and the second glass material may be a general transparent glass. The transparent glass transmits visible light, whereas the black glass blocks visible light by absorbing it. In the present embodiment, the black glass is obtained by molding black molten glass, and is one in which the glass itself is colored black. In this case, the black glass contains, as a colored component, metal ions that form a solid solution in the black glass. The black glass contains, as a colored component, for example, ions of at least one element selected from among Fe, Cr, Mn, Co, Ni, Ti, V and Cu.

When the glass itself is colored black, the black glass may contain, for example, in terms of mass % based on oxides, 50% to 75% of SiO₂, 0% to 15% of Al₂O₃, 0% to 20% of Na₂O, 0% to 20% of K₂O, 0% to 15% of MgO, 0% to 20% of CaO, 10% to 20% of B₂O₃, 0% to 20% of ΣRO (R is Mg, Ca, Sr, Ba, or Zn), 0% to 5% of ZrO₂, 1.0% to 10% of Fe₂O₃, 0% to 1% of CoO, and 0% to 0.5% of SO₃. ΣRO is a total content of MgO, CaO, SrO, BaO and ZnO.

When the glass itself is colored black, the black glass may contain at least one selected from among V₂O₅, CrO, MnO, CuO, MoO₃ and CeO₂ as long as it does not impair the coloration. A total content of V₂O₅, CrO, MnO, CuO, MoO₃, and CeO₂ in terms of mass % based on oxides is preferably 0% to 3%, and more preferably 0% to 1%.

When the glass itself is colored black, the black glass may contain, as a clarifying agent, at least one selected from among SO₃, Sb₂O₃, SnO, Cl and F as long as it does not impair the coloration. A total content of SO₃, Sb₂O₃, SnO, Cl and F is preferably 0% to 1%, and more preferably 0% to 0.5%.

Here, in the present embodiment, the black glass is a block product in which the glass itself is colored black, but it may be a sintered product obtained by firing a paste containing a transparent glass powder and a black pigment. The black pigment is dispersed in the transparent glass without forming a solid solution in the transparent glass. The black pigment is formed of, for example, a metal or metal compound containing at least one element selected from among Fe, Cr, Mn, Co, Ni, Ti and Cu. The metal compound is, for example, an oxide. The paste may contain additives other than the glass frit and the black pigment, and may contain, for example, a ceramic powder.

When the first glass material is black glass, and the black glass is a sintered product obtained by firing a paste containing a transparent glass powder and a black pigment, the following Tg1 and CTE1 may be measured using either a test piece in which a black pigment is dispersed in transparent glass or a test piece composed of only transparent glass. In either test piece, Tg1 and CTE1 have substantially the same value. Here, the composition of the transparent glass contained in the black glass can be measured by avoiding the black pigment.

The glass transition point (Tg1) of the first glass material is higher than the glass transition point (Tg2) of the second glass material. The glass transition points (Tg1 and Tg2) are measured using a differential thermal analysis device (DTA). When the glass plate 10 and the glass block 20 have a chemically strengthened layer, the chemically strengthened layer is removed to produce a test powder for the glass transition point.

When Tg1 is higher than Tg2, the glass plate 10 is less likely to deform due to heat than the glass block 20. Therefore, when the glass plate 10 and the glass block 20 are integrated while heating, the glass block 20 can be deformed to fill the hole 13 with the glass block 20 while curbing deformation of the hole 13 in the glass plate 10, and distortion of the hole 13 in the glass plate 10 can be reduced.

The ratio (Tg1/Tg2) of the glass transition point (Tg1) of the first glass material to the glass transition point (Tg2) of the second glass material is preferably 1.04 or more. When the ratio (Tg1/Tg2) is 1.04 or more, the glass block 20 can be deformed while curbing deformation of the hole 13 in the glass plate 10. The ratio (Tg1/Tg2) is more preferably 1.07 or more. A larger ratio (Tg1/Tg2) is preferable. However, the ratio (Tg1/Tg2) may be 1.20 or less.

An absolute value (ΔCTE=|CTE1−CTE2|) of the difference between the average coefficient of linear expansion (CTE1) of the first glass material and the average coefficient of linear expansion (CTE2) of the second glass material is preferably less than 35.8×10⁻⁷/° C.

When ΔCTE is less than 35.8×10⁻⁷/° C., stress generated due to temperature changes is small, and the glass is less likely to crack. ΔCTE is more preferably 23.0×10⁻⁷/° C. or less, and particularly preferably 16.0×10⁻⁷/° C. or less. A smaller ΔCTE is preferable, and ΔCTE may be zero. When ΔCTE is not zero, either CTE1 or CTE2 may be larger.

The average coefficients of linear expansion (CTE1 and CTE2) are the average coefficients of linear expansion at 50° C. to 350° C. The average coefficient of linear expansion is measured using a thermal mechanical analysis device (TMA). When the glass plate 10 and the glass block 20 have a chemically strengthened layer, the chemically strengthened layer is removed to produce a test piece. The size of the test piece is, for example, 5 mm in length, 5 mm in width, and 20 mm in height. When it is difficult to cut out a test piece from a single glass article 2, the test piece may be produced by dissolving materials cut out from a plurality of glass articles 2.

The thickness of the glass plate 10 is, for example, 0.2 mm to 5 mm. The thickness of the glass plate 10 is preferably 0.8 mm or less. When the thickness of the glass plate 10 is 0.8 mm or less, even if ΔCTE is larger than 5.0×10⁻⁷/° C., stress generated due to temperature changes is small, and the glass is less likely to crack. The glass plate 10 is, for example, a flat plate. Here, the glass plate 10 may be a curved plate. The curved plate may have a curved surface on at least a part of the surface 11 and a back surface 12, and may have a flat surface on another part.

The hole 13 is formed in the surface 11 of the glass plate 10. Processing for the hole 13 is not particularly limited, and for example, cutting processing, etching processing, laser processing, discharge processing, or blast processing may be used. A region in which the hole 13 is not formed may be protected with a mask. The hole 13 may penetrate the glass plate 10 in the thickness direction, and reach the back surface 12 of the glass plate 10. Here, the hole 13 in the present embodiment is a through-hole, but it may be a non-through-hole (that is, a bottomed hole).

When the surface 11 of the glass plate 10 is viewed from the front, as shown in FIG. 1A, the shape of the surface 11 is, for example, a rectangle. The length of one side of the rectangle is, for example, 10 mm to 100 mm. Here, the shape of the surface 11 is not limited to a rectangle, and may be, for example, a circle as shown in FIG. 6C.

When the surface 11 of the glass plate 10 is viewed from the front, as shown in FIG. 1A, the shape of the hole 13 is, for example, a circle. The diameter of the hole 13 is, for example, 10 mm to 100 mm. Here, the shape of the hole 13 is not limited to a circle, and may be a polygon. For example, the shape of the hole 13 may be a rectangle as shown in FIG. 5A, a cross as shown in FIG. 6A, or a star as shown in FIG. 6B.

A combination of the shape of the surface 11 and the shape of the hole 13 is not particularly limited. The number of holes 13 may be one, or may be multiple as shown in FIG. 6C, or may be three or more. The sizes of the plurality of holes 13 may be different as shown in FIG. 6C or may be the same. The arrangement of the plurality of holes 13 is not particularly limited. Although not shown, the plurality of holes 13 may be arranged in a ring shape or in a matrix shape. The arrangement is not particularly limited. For example, the plurality of holes 13 may be arranged in a triangular lattice shape.

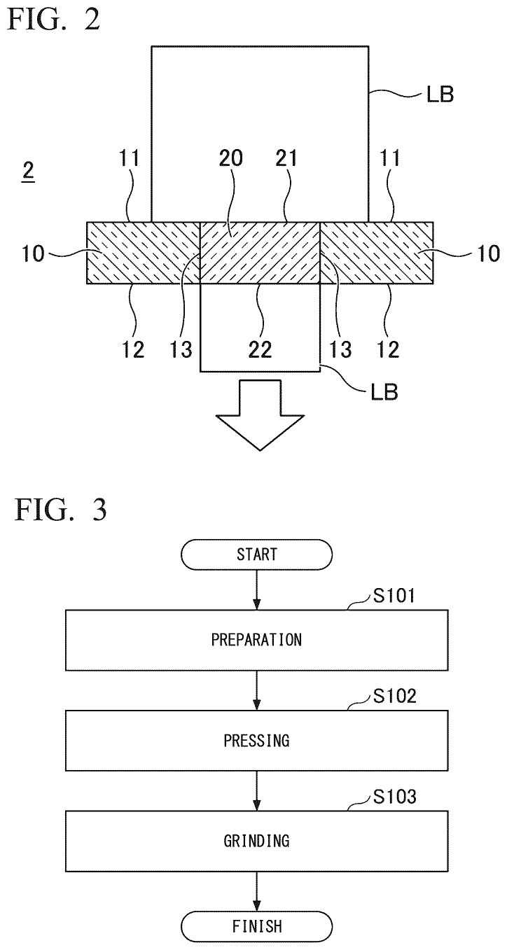

As shown in FIG. 2, the glass article 2 may be an optimal member that transmits visible light LB. For example, the hole 13 in the glass plate 10 is a through-hole, the glass plate 10 has a visible light LB transmittance of 0.1% or less, and the glass block 20 has a visible light LB transmittance of 50% or more. The glass article 2 adjusts the cross-sectional shape of visible light LB. The cross-sectional shape of visible light LB that has passed through the glass article 2 matches the cross-sectional shape of the glass block 20. The glass article 2 is used, for example, in an imaging device or an optical system of an optical sensor.

The reflectance of visible light LB at the interface between the glass block 20 and the glass plate 10 is preferably 5% or less. The interface between the glass block 20 and the glass plate 10 is the inner circumferential surface of the hole 13 and is the interface between the second glass material and the first glass material. The reflectance at the interface depends on the difference in refractive index between the second glass material and the first glass material. The smaller the difference in refractive index, the smaller the reflectance. A test piece for measuring the reflectance is produced, for example, by cutting the glass article 2 so that the glass block 20 is divided into two pieces. Visible light LB is emitted through the glass block 20 perpendicularly to the interface between the glass block 20 and the glass plate 10 and the reflectance thereof is measured.

When the reflectance of visible light LB at the interface between the glass block 20 and the glass plate 10 is 5% or less, among visible light LB propagating through the inside of the glass block 20, visible light inclined with respect to the thickness direction of the glass plate 10 can be absorbed inside the glass plate 10. As a result, generation of stray light can be minimized. The reflectance is preferably 5% or less, more preferably 3% or less, and still more preferably 1% or less. A smaller reflectance is preferable, and the reflectance may be 0%.

The transmitted wavefront aberration of visible light LB of the glass block 20 is preferably 10 times or less than the wavelength λ of visible light LB. The wavelength λ of visible light LB is, for example, 400 nm to 800 nm. The transmitted wavefront aberration is caused by a variation in the thickness of the glass block 20 or a variation in the refractive index of the glass block 20. The variation in the refractive index is caused by, for example, a variation in residual stress.

When the transmitted wavefront aberration of visible light LB of the glass block 20 is 10 times or less than λ, optical characteristics are good. The transmitted wavefront aberration is preferably 10 times or less than λ, more preferably 5 times or less than λ, and still more preferably 1 time or less than λ. A smaller transmitted wavefront aberration is preferable, and the transmitted wavefront aberration may be zero.

The difference in height between the surface 11 of the glass plate 10 and a surface 21 of the glass block 20 is preferably 10 μm or less. The height of the surface 11 of the glass plate 10 is an average value of the heights within a range of 0.5 mm to 1.0 mm from the inner circumferential surface of the hole 13. On the other hand, the height of the surface 21 of the glass block 20 is an average value of the heights over the entire range excluding a range within 0.5 mm from the inner circumferential surface of the hole 13. When the difference in height between the surface 11 of the glass plate 10 and the surface 21 of the glass block 20 is 10 μm or less, distortion during chemical strengthening is minimized. The difference in height is preferably 10 μm or less, more preferably 5 μm or less, and still more preferably 1 μm or less. A smaller difference in height is preferable, and the difference in height may be 0 μm.

The difference in height between the back surface 12 of the glass plate 10 and a back surface 22 of the glass block 20 is preferably 10 μm or less. The height of the back surface 12 of the glass plate 10 is an average value of the height within a range of 0.5 mm to 1.0 mm from the inner circumferential surface of the hole 13. On the other hand, the height of the back surface 22 of the glass block 20 is an average value of the heights over the entire range excluding a range within 0.5 mm from the inner circumferential surface of the hole 13.

When the difference in height between the back surface 12 of the glass plate 10 and the back surface 22 of the glass block 20 is 10 μm or less, distortion during chemical strengthening is minimized. The difference in height is preferably 10 μm or less, more preferably 5 μm or less, and still more preferably 1 μm or less. A smaller difference in height is preferable, and the difference in height may be 0 μm.

The glass article 2 is formed of a first glass material and a second glass material different from the first glass material. Applications of the glass article 2 are not particularly limited, and in addition to optical systems, the glass article can be applied to various electronic devices such as glass that requires design properties, for example, cases of information terminals such as smartphones and monitors such as LCDs, imaging elements such as CCD image sensors and CMOS image sensors, and cover glass for instruments with built-in infrared receiving elements for remote control and instruments with displays (display devices).

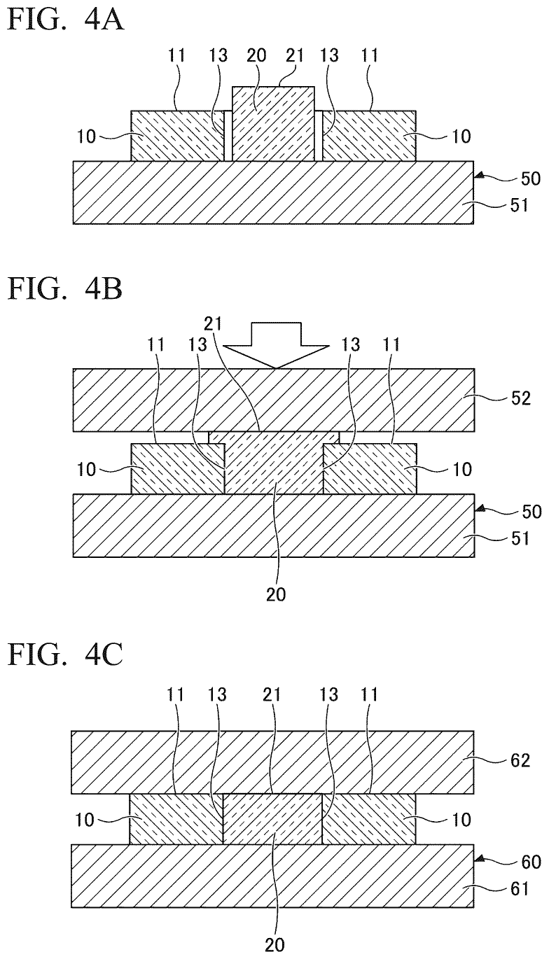

An example of a method of producing the glass article 2 will be described with reference to FIG. 3 and FIG. 4. As shown in FIG. 3, the production method includes, for example, Steps S101 to S103. Here, the production method may include steps (not shown). For example, the production method may include chemical strengthening the glass article 2 after Step S103.

Step S101 includes, for example, preparing the glass plate 10 and the glass block 20 as shown in FIG. 4A. The glass plate 10 and the glass block 20 are placed on a lower platen 51 of a pressing machine 50 with their respective surfaces 11 and 21 facing upward. The glass block 20 is disposed inside the hole 13 in the glass plate 10. The glass block 20 is thinner than the hole 13 and is higher (thicker) than the depth of the hole 13. The glass block 20 protrudes upward from the hole 13. The volume of the glass block 20 is larger than the volume of the hole 13. Here, the volume of the glass block 20 may be equal to or larger than the volume of the hole 13.

Step S102 includes, for example, as shown in FIG. 4B, pressing the glass plate 10 and the glass block 20 by inserting them between the lower platen 51 and an upper platen 52 of the pressing machine 50. The pressing machine 50 includes a heater (not shown), and integrates the glass plate 10 and the glass block 20 while heating. The heater is provided, for example, on at least one of the lower platen 51 and the upper platen 52. The temperature of the heater is at least higher than Tg2, and more preferably higher than Tg1.

According to the present embodiment, Tg1 is higher than Tg2, and the glass plate 10 is less likely to deform due to heat than the glass block 20. Therefore, when the glass plate 10 and the glass block 20 are integrated while heating, the glass block 20 can be deformed to fill the hole 13 with the glass block 20 while curbing deformation of the hole 13 in the glass plate 10, and distortion of the hole 13 in the glass plate 10 can be reduced.

Step S103 includes, for example, as shown in FIG. 4C, polishing the glass article 2 using a polishing machine 60. The polishing machine 60 includes a lower platen 61 and an upper platen 62. The lower platen 61 holds the lower surface of the glass article 2, and the upper platen 62 polishes the upper surface of the glass article 2. Thereby, the difference in height between the surface 11 of the glass plate 10 and the surface 21 of the glass block 20 can be reduced. Here, the polishing machine 60 may polish both the upper surface and the lower surface of the glass article 2 at the same time. The polishing machine 60 makes the surface 11 of the glass plate 10 and the surface 21 of the glass block 20 flush with each other.

In the following Examples 1 to 8, glass articles 2 were produced under the same conditions, except for the conditions shown in Table 1, and the presence of cracks and distortion of the hole 13 were checked. Examples 2, 3 and 6 were examples, and Examples 1, 4, 5, 7 and 8 were comparative examples. In Examples 1 to 8, as the glass plate 10, a glass plate having a length of 15 mm, a width of 15 mm, and a thickness of 0.8 mm was prepared. Thus, as the hole 13, one circular hole with a diameter of 4.5 mm was formed to penetrate the center of the glass plate 10 by drilling. Then, when the glass block 20 was disposed in the hole 13 in the glass plate 10 as shown in FIG. 4A, the glass plate 10 and the glass block 20 were inserted between the lower platen 51 and the upper platen 52 of the pressing machine 50 and pressed as shown in FIG. 4B. The pressing temperature Tp at this time is shown in Table 1. After pressing, the glass article 2 was cooled to room temperature, and the presence of cracks and distortion of the hole 13 were checked. The experimental results of Examples 1 to 8 are shown in Table 1 together with the experimental conditions.

TABLE 1

| | Tg1 | CTE1 | Tg2 | CTE2 | Tg1/ | ΔCTE | Tp | | |
|---|---|---|---|---|---|---|---|---|---|
| | [° C.] | [10⁻⁷/° C.] | [° C.] | [10⁻⁷/° C.] | Tg2 | [10⁻⁷/° C.] | [° C.] | Crack | Distortion |
| Example 1 | 594 | 94.2 | 525 | 32.5 | 1.13 | 61.7 | 658 | x | — |
| Example 2 | 594 | 94.2 | 557 | 72.0 | 1.07 | 22.2 | 658 | ∘ | ∘ |
| Example 3 | 594 | 94.2 | 536 | 94.0 | 1.11 | 0.2 | 658 | ∘ | ∘ |
| Example 4 | 594 | 94.2 | 504 | 130.0 | 1.18 | 35.8 | 580 | x | — |
| Example 5 | 557 | 72.0 | 525 | 32.5 | 1.06 | 39.5 | 606 | x | — |
| Example 6 | 557 | 72.0 | 536 | 94.0 | 1.04 | 22.0 | 619 | ∘ | ∘ |
| Example 7 | 557 | 72.0 | 504 | 130.0 | 1.11 | 58.0 | 580 | x | — |
| Example 8 | 557 | 72.0 | 594 | 94.2 | 0.94 | 22.2 | 698 | ∘ | x |

In Table 1, a crack evaluation of “∘” indicates that no cracks occurred after pressing, and a crack evaluation of “x” indicates that cracks occurred after pressing. In addition, in Table 1, a distortion evaluation of “∘” indicates that the change in roundness before and after pressing was 10 times or less, and a distortion evaluation of “x” indicates the change in roundness before and after pressing exceeded 10 times. The roundness was measured using a measuring microscope.

As shown in Table 1, in Examples 2, 3 and 6, unlike Example 8, Tg1 was higher than Tg2. Therefore, in Examples 2, 3 and 6, unlike Example 8, the change in roundness before and after pressing was 10 times or less. Here, in Examples 1, 4, 5 and 7, since cracks occurred during pressing, a change in roundness could not be measured.

In addition, as shown in Table 1, in Examples 2, 3, 6 and 8, unlike Examples 1, 4, 5, and 7, ΔCTE was less than 35.8×10⁻⁷/° C. Therefore, in Examples 2, 3, 6 and 8, unlike Examples 1, 4, 5 and 7, no cracks occurred after pressing.

While the glass article and the electronic device according to the present disclosure have been described above, the present disclosure is not limited to the above embodiments. Various changes, modifications, substitutions, additions, deletions and combinations can be made within the scope of the claims. Such variations are naturally included in the technical scope of the present disclosure.

Priority is claimed on Japanese Patent Application No. 2023-169969, filed Sep. 29, 2023, the content of which is incorporated herein by reference.

### REFERENCE SIGNS LIST

2 Glass article
10 Glass plate
11 Front surface
13 Hole
20 Glass block

1. A glass article, comprising:
a glass plate having a hole in a surface; and
a glass block that fills the hole in the glass plate,
wherein the glass plate is formed of a first glass material, and the glass block is formed of a second glass material having a different composition from the first glass material,
a glass transition point (Tg1) of the first glass material is higher than a glass transition point (Tg2) of the second glass material, and
an absolute value (ΔCTE=(CTE1−CTE2|) of a difference between an average coefficient of linear expansion (CTE1) of the first glass material and an average coefficient of linear expansion (CTE2) of the second glass material is less than 35.8×10⁻⁷° C.

2. The glass article according to claim 1, wherein a ratio (Tg1/Tg2) of the glass transition point (Tg1) of the first glass material to the glass transition point (Tg2) of the second glass material is 1.04 or more.

3. The glass article according to claim 1, wherein an absolute value (ΔCTE=|CTE1−CTE2|) of a difference between an average coefficient of linear expansion (CTE1) of the first glass material and an average coefficient of linear expansion (CTE2) of the second glass material is 23.0×10⁻⁷/° C. or less.

4. The glass article according to claim 1, wherein the glass plate has a thickness of 0.8 mm or less.

5. The glass article according to claim 1,
wherein the hole is a through-hole,
the glass plate has a visible light transmittance of 0.1% or less, the glass block has a visible light transmittance of 50% or more, and
the glass article is an optimal member that transmits visible light.

6. The glass article according to claim 5, wherein the reflectance of visible light at an interface between the glass block and the glass plate is 5% or less.

7. The glass article according to claim 5, wherein the transmitted wavefront aberration of visible light of the glass block is 10 times or less the wavelength of visible light.

8. The glass article according to claim 1, wherein the difference in height between the surface of the glass plate and a surface of the glass block is 10 μm or less.

9. The glass article according to claim 1, wherein the first glass material and the second glass material each contain 1 mol % to 30 mol % of Al₂O₃ and 1 mol % to 20 mol % of Na₂O.

10. The glass article according to claim 1, wherein the glass plate and the glass block each have a chemically strengthened layer.

11. An electronic device, comprising the glass article according to claim 1.
